(19) United States
(12) Patent Application Publication
(10) Pub. No.: US 2013/0191211 A1
(43) Pub. Date: Jul. 25, 2013

(54) CUSTOMIZING PRINTED PRODUCTS BASED ON TRAVEL PATHS

(71) Applicants: Timothy L. Nichols, Spencerport, NY (US); Thomas Joseph Murray, Cohocton, NY (US); Thiagarajah Arujunan, Penfield, NY (US); Kenneth Alan Parulski, Rochester, NY (US); Brian Joseph O'Keefe, Rochester, NY (US)

(72) Inventors: Timothy L. Nichols, Spencerport, NY (US); Thomas Joseph Murray, Cohocton, NY (US); Thiagarajah Arujunan, Penfield, NY (US); Kenneth Alan Parulski, Rochester, NY (US); Brian Joseph O'Keefe, Rochester, NY (US)

(21) Appl. No.: 13/356,946

(22) Filed: Jan. 24, 2012

(51) Int. Cl. G06Q 30/02

(52) U.S. Cl. 705/14.49; 705/14.4

(57) ABSTRACT

A method for providing customized printed products at a printing location, including storing a collection of prestored information associated with a plurality of different travel paths, receiving a digital message from a wireless device positioned at a first location, transmitting an offer to provide a printed product at the printing location; determining a travel path between the first capture location and the printing location, selecting particular prestored information responsive to the determined travel path; and providing a customized printed product at the printing location which includes the selected particular prestored information.

### CROSS REFERENCE TO RELATED APPLICATIONS

Reference is made to commonly-assigned, co-pending U.S. patent application Ser. No. 13/168,003, filed Jun. 24, 2011, entitled “Guidance for image capture at different locations” by Timothy L. Nichols, et al., U.S. patent application Ser. No. 13/168,027, filed Jun. 24, 2011, entitled “Photo Product Using Images from Different Locations” by Brian J. O'Keefe, et al., and U.S. patent application Ser. No. 13/168,043, filed Jun. 24, 2011, entitled “Imaging Device Providing Capture Location Guidance” by Thiagarajah Arujunan, et al., the disclosures of which are incorporated herein.

### FIELD OF THE INVENTION

The present invention relates to printing systems, and more particularly to network connected printing systems which provide customized printed products.

### BACKGROUND OF THE INVENTION

Mobile phones, tablet computers, networked cameras, and other portable devices incorporating camera modules and network connections to the Internet have opened up opportunities for new and exciting gaming, entertainment, and structured learning experiences. This technology is currently used to create geocache treasure hunt games and photo-based scavenger hunt games. It is also used to enable museum tours as well as tours of historic areas and other tourist attractions. In some cases, mobile games or experiences are provided, or modified, based on the location of the user. For instance, the Geocache Navigator, from Trimble Navigation Limited, Sunnyvale, Calif. is an application (APP) for a Smartphone which uses the phone's GPS and internet connections to access live information directly from geocaching.com. This enables a user to locate geocache challenges which are closest to their current location.

It is known to provide advertising for businesses, such as stores or restaurants, based on a user's current location, such as the location of their home as they use their home computer. Also, many location-based Smart Phone “Apps”, such as “Yelp” and “Where”, have been developed in order to enable users to locate businesses and services near the current position of the user's smart phone.

It is known to provide preference-aware location-based services, as described in the paper titled “Toward context and preference-aware location-based services” authored by Mokbel et al. Such systems tailor their services based on the preference and context of each customer. For example, in a restaurant finder application, the system can use the dietary restrictions, price range, other user ratings, current traffic, and current waiting time to recommend nearby restaurants to the customer, rather than recommending all of the closest restaurants.

Photography is often used to record and share experiences, such as vacation trips, family outings, or seasonal events. Still and video images of such experiences can be captured using image capture devices such as camera phones, digital cameras, and camcorders. The digital images captured by these image capture devices can be shared by e-mail and uploaded to web sites such as Facebook and Flickr, where they can be viewed by friends. The uploaded images can be printed using photo service providers, such as the Kodak Gallery at www.kodakgallery.com. Users can order photo products, such as photo books and collages, which use uploaded digital images.

It is known to produce enhanced photo products by combining images captured with an image capture device and professionally produced digital content, as described in commonly-assigned U.S. patent application, Ser. No. 11/626,471 (published as 20080174676), “Producing enhanced photographic products from images captured at known events” to Squilla, et al, incorporated herein by reference. The system includes a database for storing custom content for a plurality of events. The system also includes a digital image capture device that stores a digital image and information defining the date/time and geographic location of the digital image. A service provider automatically determines if the timestamp and the geographic information corresponds to events stored in the custom content database. A processor produces an enhanced photographic product including the captured digital image and custom content corresponding to the timestamp and location of the captured digital image.

It is known to use image recognition techniques to produce a photocollage from a plurality of images, as described in commonly-assigned U.S. Pat. No. 6,389,181 “Photocollage generation and modification using image recognition” to Shaffer et al, incorporated herein by reference. The system sorts digital records associated with a plurality of images, by culling or grouping to categorize the records according to an event, person, or chronology, in order to automatically compose a photo collage.

However, there remains a need to provide customized printed products at a printing location which is which is based on the travel path of a user.

### SUMMARY OF THE INVENTION

In accordance with the invention, there is provided a method for providing customized printed products at a printing location, comprising:

a) storing a collection of prestored information associated with a plurality of different points along travel paths,

b) receiving, over a wireless communications network, a digital message from a wireless device positioned at a first location;

c) transmitting, to the wireless device, an offer to provide a printed product at the printing location;

d) determining a travel path between the first capture location and the printing location;

e) selecting particular prestored information responsive to the determined travel path; and

f) providing a customized printed product at the printing location, wherein the customized printed product includes the selected particular prestored information.

It is an advantage of the present invention to provide printed products which have been customized for a user of a wireless device.

It is a further advantage of the present invention to provide printed products which have been customized responsive to the location of the user of the wireless device.

It is a feature of the invention that printed products are customized using particular prestored information responsive to a travel path between a capture location and a printing location.

### BRIEF DESCRIPTION OF THE DRAWINGS

FIG. 1 is a block diagram of a digital imaging system in accordance with an embodiment of the present invention;

FIG. 2 is a block diagram of a camera phone used in the digital imaging system of FIG. 1;

FIG. 3 is a high level flow diagram depicting steps for providing customized printed products at a printing location;

FIG. 4 depicts a shopping mall map which includes travel paths between a plurality of image capture locations and a printing location inside the shopping mall;

FIG. 5A depicts a user interface screen for capturing images using a wireless device;

FIG. 5B depicts a user interface screen for providing a product offer on a wireless device;

FIGS. 6A and 6B depict pages of printed products customized for two different participants;

FIGS. 7A and 7B depict pages of printed products customized for the travel paths of two different participants; and

FIG. 8A and FIG. 8B depict examples of printed products customized for the travel paths of two different users.

It is to be understood that the attached drawings are for purposes of illustrating the concepts of the invention and may not be to scale.

### DETAILED DESCRIPTION OF THE INVENTION

In the following description, some embodiments of the present invention will be described in terms that would ordinarily be implemented as a software program. Those skilled in the art will readily recognize that the equivalent of such software can also be constructed in hardware. Because image manipulation algorithms and systems are well known, the present description will be directed in particular to algorithms and systems forming part of, or cooperating more directly with, the system and method in accordance with the present invention. Other aspects of such algorithms and systems, and hardware or software for producing and otherwise processing the image signals involved therewith, not specifically shown or described herein, can be selected from such systems, algorithms, components and elements known in the art. Given the system as described according to the invention in the following materials, software not specifically shown or described herein that is useful for implementation of the invention is conventional and within the ordinary skill in such arts.

Still further, as used herein, a computer program for performing the method of the present invention can be stored in a non-transitory computer readable storage medium, which can include, for example; magnetic storage media such as a magnetic disk (e.g., a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program having instructions for controlling one or more computers to practice the method according to the present invention.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

Because wireless image capture devices and systems, such as camera phones connected via cellular telephone systems to service providers using the Internet are well known, the present description will be directed in particular to elements forming part of, or cooperating more directly with, the method and apparatus in accordance with the present invention. Elements not specifically shown or described herein are selected from those known in the art. Certain aspects of the embodiments to be described are provided in software. Given the system as shown and described according to the invention in the following materials, software not specifically shown or described herein that is useful for implementation of the invention is conventional and within the ordinary skill in such arts.

The following description of image capture devices and imaging systems will be familiar to one skilled in the art. It will be obvious that there are many variations of this embodiment that are possible and are selected to reduce the cost, add features, or improve the performance of these devices and systems. The present invention is illustrated by way of example and not a limitation in the accompanying figures.

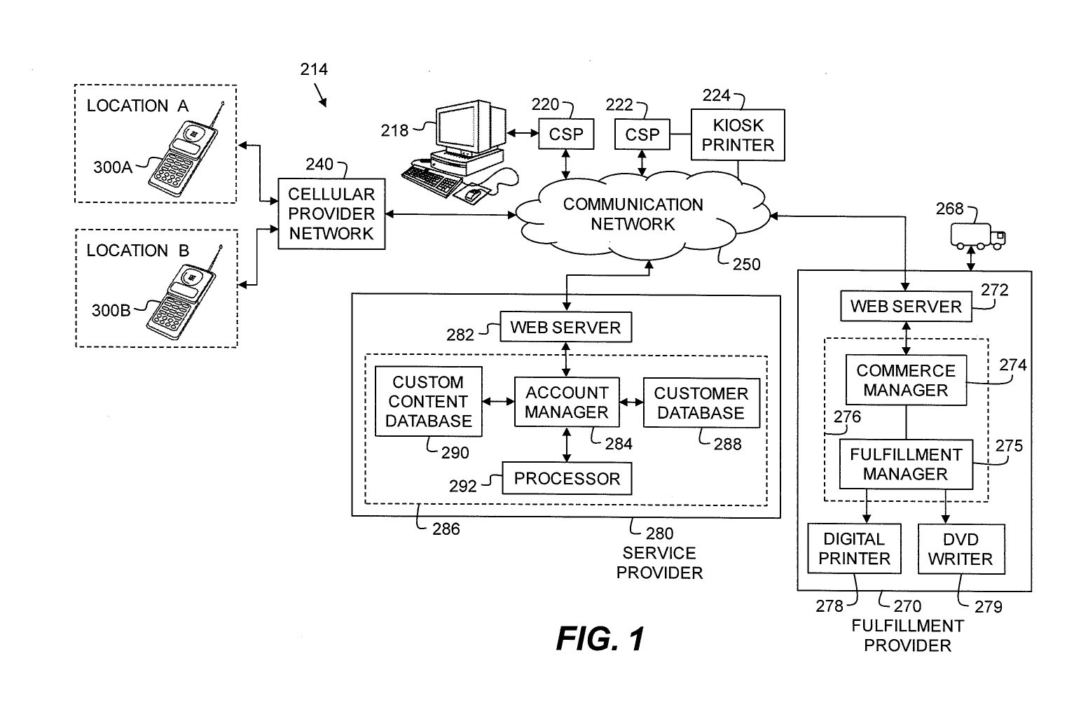

Referring to FIG. 1, there is illustrated a system 214 for capturing digital images along with location and time information, and using the images and information to provide customized printed products, including printed photo products. As used herein the term digital image includes both digital still images and digital video images. A first camera phone 300A, located at a first location A, and a second camera phone 300B, located at a second location B, can communicate using a cellular provider network 240. The cellular provider network 240 provides data communications using transmission devices located at cell towers throughout a region. In some embodiments, the data communications provided by the cellular provider network 240 are also used to provide mobile telephone communications. The cellular provider network 240 is coupled to a communication network 250, such as the Internet. It will be understood that system 214 typically includes many other camera phones, in addition to camera phone 300A and camera phone 300B. It will be understood that the system 214 can include multiple cellular provider networks 240, for example networks provided by companies such as Verizon, AT&T, and Sprint, which can be coupled to the communication network 250.

The communications network 250 enables communication with a service provider 280. Service provider 280 includes a web server 282 for interfacing with communications network 250. In addition to interfacing to communications network 250, web server 282 transfers information to a computer system 286 which manages images and information associated with various customers and with prestored information associated with different locations and events. It will be understood that the system 214 can include a plurality of service providers 280, which provide different services and can support different regions of the world.

The computer system 286 includes an account manager 284, which runs software to permit the creation and management of individual customer photo imaging accounts and to also permit the creation and management of collections of prestored information, such as professional images, advertising, and other content associated with various events and locations. The customer images and associated information are stored in a customer database 288. The customer account information can include personal information such as name and address, billing information such as credit card information, and authorization information that controls access to the customer's images by third parties. The professional images, advertising and other prestored information associated with the supported events and locations are stored in custom content database 290.

Thus, the customer database 288 stores customer image files and related metadata, such as location and time information which identifies the location at which the image was captured, the phone number, serial number or another identifier of the camera phones 300A, 300B which captured the image, and the time of capture. The custom content database 290 stores prestored information, such as professionally captured images and other information, such as captions, titles, text, graphics, templates, and related metadata. For example, the custom content database 290 can store images and other information related to particular vacation destinations (e.g. Washington DC, New York City, Cape May N.J.) and particular events (Rose Bowl Parade, Professional Sports events, Major Concerts). The custom content database 290 includes an index providing location or event data such as the GPS coordinate boundaries of locations, object identifying feature points, object identifying color profiles, or the time boundaries of events, so that locations (such as Cape May or Yellowstone National Park) and events (such as the Rose Bowl Parade or the Rochester Lilac Festival) can be identified.

The custom content database 290 also stores guidance information, which is used to provide guidance to a user concerning what images should be captured by a user in a general location. In some embodiments, the guidance information provides locations which are likely to be considered to be good “photo spots” by the particular user of one of the camera phones 300A, 300B. In some embodiments, the guidance information includes at least one image related to the location. For example, the guidance can include a photo of a particular object, along with a text message that provides a general direction, or other clues, for locating the object. In some embodiments, the guidance can also include text or graphics which instruct the user to capture an image of their group near the object, and to transmit the image to the service provider.

In some embodiments, guidance for capturing images at different locations is provided in a manner so as to dynamically alter the photo-based experience responsive to input received during the experience. In this way, the experience adapts to a particular user's situation and conditions. For example, a photo submitted at one point in the experience can indicate that the user is accompanied by children. This can result in future experience objectives more suitable to a younger audience. In another example, input received from the user can indicate that it is raining or snowing. In this condition, future experience objectives can be tailored to indoor venues.

The computer system 286 includes a processor 292, which is used to analyze the pixel data of some of the customer images which are uploaded and stored in the customer database 288. For example, in some embodiments the processor 292 can analyze the pixel data in order to detect faces in one or more customer images using a variety of known face detection algorithms. Such algorithms are described, for example, in a paper titled “Comparative Testing of Face Detection Algorithms” by Degtyarev et al., which is available from http://lda.tsu.tula.ru/papers/degtyarev-2010-icisp-ctfd.pdf and is incorporated herein by reference. In some embodiments, the face detection algorithm determines the number of faces that can be detected in an image, in order to determine how many people are depicted in the image. In some embodiments, the face detection algorithm determines the approximate ages of the people whose faces have been detected. It will be understood that the term approximate age, as used herein, relates to categorizing one or more faces into age-related categories. These age categories can include, for example, babies, young children, teens, younger adults, and older adults (i.e. senior citizens).

In some embodiments, the processor 292 in the computer system 286 can analyze the pixel data of some of the customer images in order to determine whether one or more landmarks are depicted in the images. Such image recognition algorithms are used, for example, in the Google Goggles Application (APP) for the Android mobile platform, which is available from Google, Mountain View, Calif.

In some embodiments, the processor 292 in the computer system 286 creates the information needed to provide a unique photo product for a particular user of one of the mobile phones 300A, 300B by incorporating images captured during the user's photo-based experience with prestored information, such as professional images and textual descriptions. This enables a photo product to be automatically created by placing the captured images in predetermined locations in the photo product, so that they are associated with the prestored information. For example, a first image captured near the Lincoln Memorial in Washington DC can be associated with prestored information which describes the presidency of Abraham Lincoln and provides professional photographs of the Lincoln Memorial or an image related to his Gettysburg Address speech. A second image, captured near the White House, can be associated with prestored information that describes or depicts the current president or the construction of the White House.

In some embodiments, the processor 292 in the computer system 286 modifies the appearance of one or more of the captured digital images, so that it has a more suitable appearance when incorporated into the photo product. In some embodiments, faces in the captured digital image can be detected, and the processor 292 can crop the digital image to enlarge the size of the faces and remove some of the distracting background surrounding the face.

In some embodiments, captured digital images can be processed by the processor 292 to provide a different image appearance. For example, captured digital images can be processed so that the newly captured images appear to be older photographs, such as daguerreotypes, so that they have a more suitable appearance when positioned in a photo product in association with an image related to the Gettysburg Address. As another example, the captured digital images can be processed to provide an image having a different color tint, contrast, or external shape, so that it has a more suitable appearance when positioned in a photo product as part of an advertisement for a product or service. As another example, the captured digital images can be processed to provide a cartoon effect or a coloring book effect so that they have a more suitable appearance when positioned in a children's photo product in association with prestored cartoons or as part of a page which provides a “coloring book” for a child.

In some embodiments, captured digital images can be processed by the processor 292 to provide a different image appearance in response to the image content of the captured image. For example, the processor 292 can determine the location of multiple faces within the image and automatically crop the captured digital image using different aspect ratios for different captured images in order to produce a more suitable appearance in the photo product.

In some embodiments, the captured digital images can be processed by the processor 292 to provide a different image appearance in response to the location where the image was captured. For example, the processor 292 can provide a “cartoon” effect for images captured in a particular location, such as images captured in a particular park or playground.

In some embodiments, the captured digital images can be processed by the processor 292 to provide a different image appearance in response to both the image content of the captured image and the location where the image was captured. For example, the processor 292 can provide a color-based object extraction algorithm (e.g. “green screen” effect”) on images captured in a particular location when the processor 292 can determine that a background area of the captured image is a predetermined color (e.g. green).

The communications network 250 enables communication with a fulfillment provider 270. The fulfillment provider 270 produces and distributes enhanced photo products. The fulfillment provider 270 includes a fulfillment web server 272, and a fulfillment computer system 276 that further includes a commerce manager 274 and a fulfillment manager 275. Fulfillment requests received from service provider 280 are handled by commerce manager 274 initially before handing the requests off to fulfillment manager 275. Fulfillment manager 275 determines which equipment is used to fulfill the ordered good(s) or services such as a digital printer 278 or a DVD writer 279. The digital printer 278 represents a range of color hardcopy printers that can produce various photo products, including prints and photo albums. The hardcopy prints can be of various sizes, including “poster prints”, and can be sold in frames. The DVD writer 279 can produce CDs or DVDs, for example PictureCDs, having digital still and video images and application software for using the digital images.

After fulfillment, the photo products are provided to the user of the camera phones 300A, 300B. In some embodiments, the photo products are provided at a retail outlet, for pickup by the user of the camera phones 300A, 300B, or by a designated recipient. In some embodiments, some of the photo products are provided using a transportation vehicle 268.

System 214 also includes one or more kiosk printers 224 which communicate with the communication network 250 and service provider 280 via a communication service provider (CSP) 222. This enables printed photo products, created by the service provider 280 using digital images captured by camera phones 300A, 300B, to be provided at small retail establishments, such as toy stores or fast food retailers.

System 214 also includes one or more customer computers 218 which communicate with the communication network 250 and service provider 280 via a communication service provider (CSP) 220. This enables photo products, created by the service provider 280 using digital images captured by camera phones 300A, 300B, to be ordered at a later time by the user of the camera phones 300A, 300B, or by others who are authorized by the user of the camera phones 300A, 300B.

It will be understood that in some embodiments, a plurality of service providers 280, fulfillment providers 270 or kiosk printers 224 can be located at a plurality of different retail outlets. For example, fulfillment providers 270 can be located in a portion of a store which is near a vacation spot or other attraction. In some embodiments, the user of the camera phones 300A, 300B can be guided to the location of a nearby fulfillment provider 270 in order to pick up a photo product that has been produced using their captured digital images. In some embodiments, the user of the camera phones 300A, 300B receives the photo product at a discount, or free of charge, in order to encourage the user to enter the store where they can purchase other items. In some embodiments, the photo product includes advertising of merchants which are located near the location of the fulfillment provider 270.

In some embodiments, the service provider 280, or the fulfillment provider 270 can create examples of various photo products that can be provided by the fulfillment provider 270, as described in commonly-assigned U.S. Pat. No. 6,915,273, entitled “Method For Providing Customized Photo Products Over A Network” by Parulski et al., the disclosure of which is incorporated herein by reference. The examples can be communicated to the camera phones 300A, 300B or the customer computer 218, where the examples can be displayed to the user.

In some embodiments, the customer database 288 at the service provider 280 includes information describing customer accounts for a plurality of users, including user billing information. The billing information can include a payment identifier for the user, such as a charge card number, expiration date, user billing address, or any other suitable identifier. In some embodiments, the customer database 288 also provides long-term storage of the uploaded images for some or all of the users. In some embodiments, stored images are accessible (e.g., viewable) via the Internet by authorized users. Users can be authorized to view, print, or share images as described in commonly-assigned U.S. Pat. No. 5,760,917, entitled “Image distribution method and system” to Sheridan, the disclosure of which is incorporated herein by reference.

When a photo product is purchased by the user of the camera phones 300A, 300B, the service provider account manager 284 can communicate with a remote financial institution (not shown) to verify that the payment identifier (e.g., credit card or debit card number) provided by the customer is valid, and to debit the account for the purchase. Alternatively, the price of the photo product can be added to the user's monthly bill paid to the service provider 280 or to their mobile phone operator.

It will be understood that in some embodiments, the functions of the service provider 280 and the fulfillment provider 270 can be combined, for example, by using a common web server for both web server 282 and web server 272 or by combining the functions of the account manager 284, the commerce manager 274, and the fulfillment manager 275. It will be understood that in some embodiments, the customer database 288 or the custom content database 290 can be distributed over several computers at the same physical site, or at different sites.

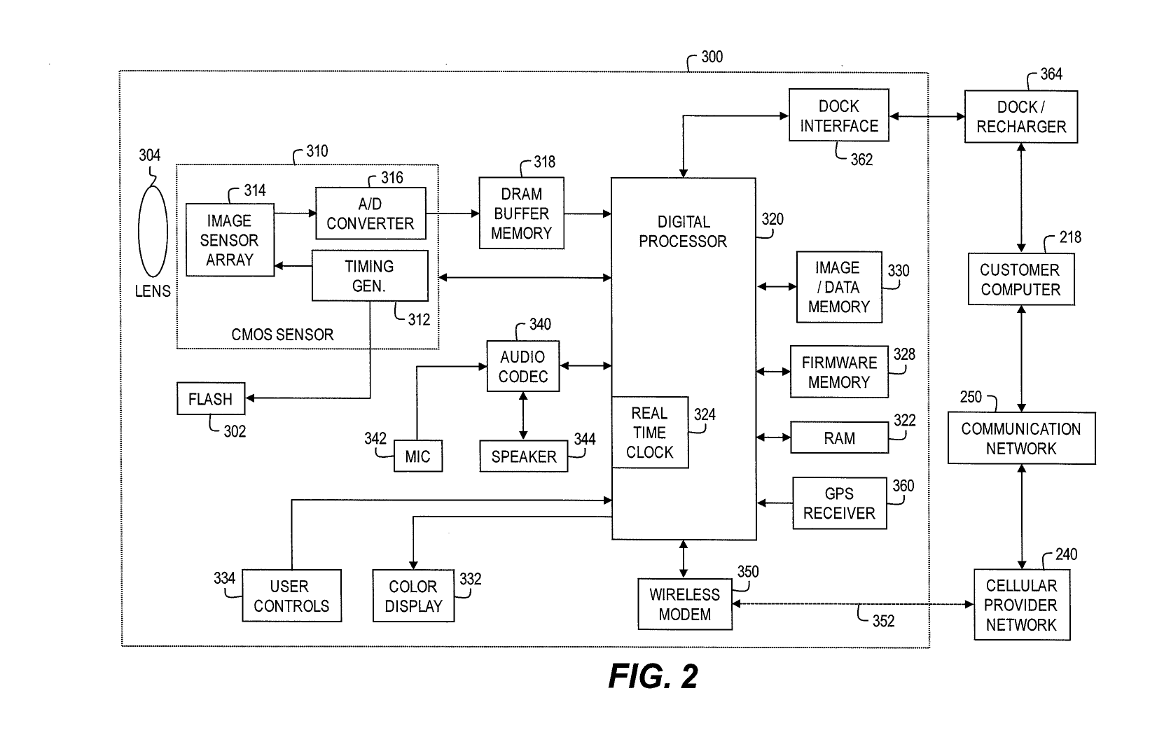

FIG. 2 depicts a block diagram of a camera phone 300 used in the digital photography system of FIG. 1. The camera phone 300 can send and receive email messages and text messages which include images. It will be understood that other types of image capture devices, such as a wireless digital camera, can be used in the system described in reference to FIG. 1. The camera phone 300 or other type of image capture device can also include other functions, including, but not limited to, the functions of a digital music player (e.g. an MP3 player), a GPS receiver, or a programmable digital assistant (PDA).

The camera phone 300 is a portable battery operated device, small enough to be handheld by a user when capturing and reviewing images. The camera phone 300 includes a lens 304 which focuses light from a scene (not shown) onto an image sensor array 314 of a CMOS image sensor 310. The image sensor array 314 can provide color image information using the well-known Bayer color filter pattern. The image sensor array 314 is controlled by timing generator 312, which also controls a flash 302 in order to illuminate the scene when the ambient illumination is low. The image sensor array 314 can have, for example, 2560 columns×1920 rows of pixels.

In some embodiments, the digital camera phone 300 can also store video clips by summing multiple pixels of the image sensor array 314 together (e.g. summing pixels of the same color within each 4 column×4 row area of the image sensor array 314) to create a lower resolution video image frame. The video image frames are read from the image sensor array 314 at regular intervals, for example using a 30 frame per second readout rate.

The analog output signals from the image sensor array 314 are amplified and converted to digital data by the analog-to-digital (A/D) converter circuit 316 on the CMOS image sensor 310. The digital data is stored in a DRAM buffer memory 318 and subsequently processed by a digital processor 320 controlled by the firmware stored in firmware memory 328, which can be flash EPROM memory. The digital processor 320 includes a real-time clock 324, which keeps the date and time even when the digital camera phone 300 and digital processor 320 are in their low power state. The digital processor 320 produces digital images that are stored as digital image files using image/data memory 330. The phrase “digital image” or “digital image file”, as used herein, refers to any digital image file, such as a digital still image or a digital video file.

The processed digital image files are stored in the image/data memory 330, along with the date/time that the image was captured provided by the real-time clock 324 and the location information provided by GPS receiver 360. The image/data memory 330 can also be used to store other information, such as phone numbers or appointments. In some embodiments, the camera phone 300 is a smart phone, and the digital processor 320 uses a software stack, such as Android, which includes an operating system, middleware, and applications. This permits a software application (“APP”) to be downloaded, stored in the firmware memory 328, and used to provide various functions.

In some embodiments, the digital processor 320 performs color interpolation followed by color and tone correction, in order to produce rendered sRGB image data. In some embodiments, the digital processor 320 can also provide various image sizes selected by the user. In some embodiments, rendered sRGB image data is then JPEG compressed and stored as a JPEG image file in the image/data memory 330. In some embodiments, the JPEG file uses the so-called “Exit” image format. This format includes an Exif application segment that stores particular image metadata using various TIFF tags. Separate TIFF tags are used to store the date and time the picture was captured and the GPS co-ordinates, as well as other camera settings such as the lens f/number.

In some embodiments, the digital processor 320 also creates a low-resolution “thumbnail” size image, which can be created as described in commonly-assigned U.S. Pat. No. 5,164,831, entitled “Electronic Still Camera Providing Multi-Format Storage Of Full And Reduced Resolution Images” to Kuchta, et al., the disclosure of which is herein incorporated by reference. The thumbnail image can be stored in RAM memory 322 and supplied to a color display 332, which can be, for example, an active matrix LCD or organic light emitting diode (OLED). After images are captured, they can be quickly reviewed on the color LCD image display 332 by using the thumbnail image data.

The graphical user interface displayed on the color display 332 is controlled by user controls 334. The graphical user interface enables the user to control the functions of the camera phone 300, for example, to capture still or video images, and to send or view text messages or email messages. User controls 334 typically include some combination of buttons, rocker switches, or joysticks. In some embodiments, many of the user controls 334 are provided by using a touch screen overlay on the color display 332. In other embodiments, the user controls 334 can include a way to receive input from the user or an external device via a tethered, wireless, voice activated, visual or other interface. In other embodiments, additional status displays or images displays can be used.

An audio codec 340 connected to the digital processor 320 receives an audio signal from a microphone 342 and provides an audio signal to a speaker 344. These components can be used both for telephone conversations and to record and playback an audio track, along with a video sequence or still image. The speaker 344 can also be used to inform the user of an incoming phone call. This can be done using a standard ring tone stored in firmware memory 328, or by using a custom ring-tone downloaded from the service provider 280. In addition, a vibration device (not shown) can be used to provide a silent (e.g., non audible) notification of an incoming phone call, e-mail, or text message.

A dock interface 362 can be used to connect the camera phone 300 to a dock/charger 364, which is connected to the customer computer 218. The dock interface 362 can conform to, for example, the well-know USB interface specification. Alternatively, the interface between the digital camera phone 300 and customer computer 218, can be a wireless interface, such as the well-known Bluetooth wireless interface or the well-known 802.11b wireless interface. The dock interface 362 can be used to download image files (which include the date/time and GPS coordinates) from the image/data memory 330 to the customer computer 218. The dock/charger 364 can also be used to recharge the batteries (not shown) in the digital camera phone 300.

The digital processor 320 is coupled to a wireless modem 350, which enables the digital camera phone 300 to transmit and receive information via an RF channel 352. The wireless modem 350 communicates over a radio frequency (e.g. wireless) link with the cellular provider network 240, which can use, for example, a CDMA network, a 3GSM, a 4 GSM network, or other wireless communication networks 250.

It will be understood that the functions of digital processor 320 can be provided using a single programmable processor or by using multiple programmable processors, including one or more digital signal processor (DSP) devices. Alternatively, the digital processor 320 can be provided by custom circuitry (e.g., by one or more custom integrated circuits (ICs) designed specifically for use in camera phones), or by a combination of programmable processor(s) and custom circuits. It will be understood that connectors between the digital processor 320 from some or all of the various components shown in FIG. 2 can be made using a common data bus. For example, in some embodiments the connection between the digital processor 320, the DRAM buffer memory 318, the image/data memory 330, and the firmware memory 328 can be made using a common data bus.

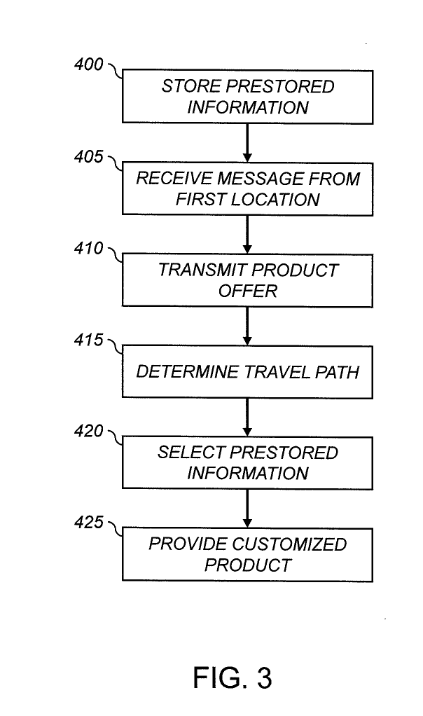

FIG. 3 is a high level flow diagram depicting steps for providing customized printed products at a printing location. In some embodiments, all of the steps are performed by the service provider 280 in FIG. 1. In other embodiments, some of the steps are performed by the camera phone 300 in FIG. 2. In some embodiments, guidance is provided by the service provider 280 to enable user experiences where images are captured and the pixel data of the captured image is analyzed so that the experience can be dynamically modified based on information determined as a result of the analysis of the captured images, as described in commonly-assigned U.S. patent application Ser. No. 13/168,003 filed Jun. 24, 2011, entitled “Guidance for image capture at different locations” by Timothy L. Nichols, et al., incorporated herein by reference.

In stored prestored information step 400 of FIG. 3, a collection of prestored information associated with a plurality of different points along travel paths is stored. In some embodiments, the collection of prestored information is stored by the service provider 280 in the custom content database 290 in association with location information, such as GPS information. The prestored information can be associated with a high-traffic area, such as a historic district, an amusement park or a shopping mall.

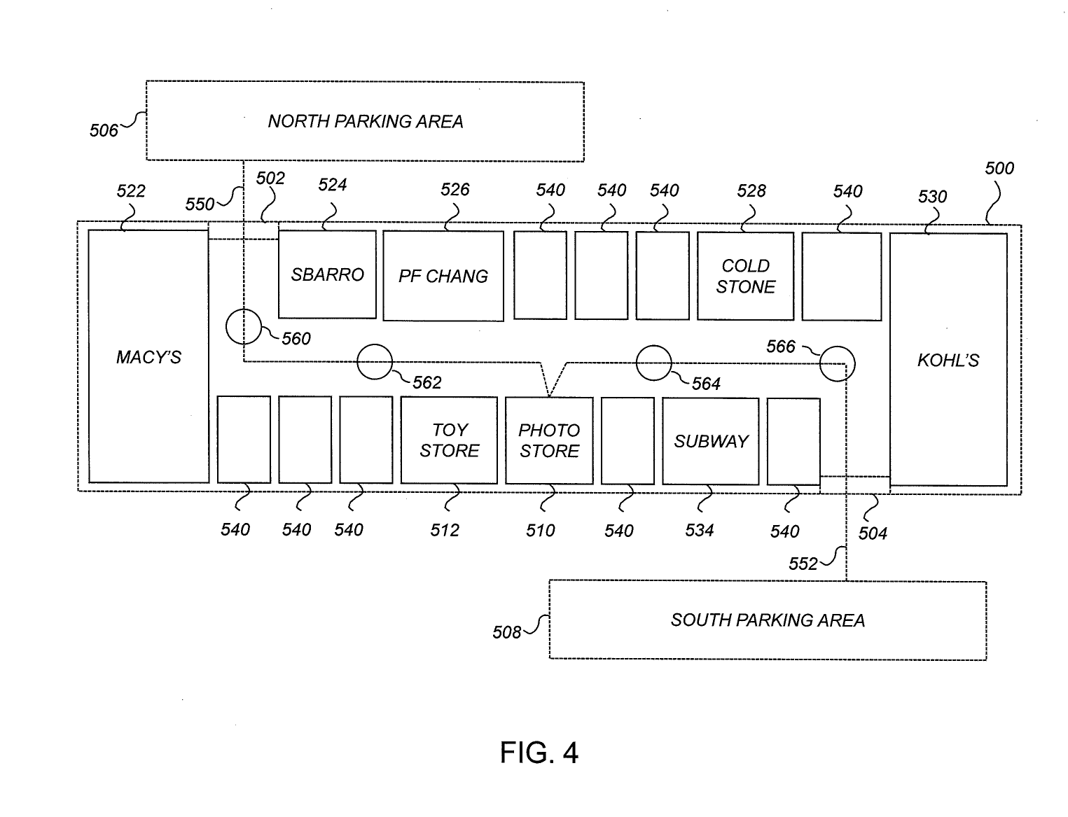

FIG. 4 depicts a map of a shopping mall 500. Some visitors to the shopping mall 500 park their cars in a North parking area 506 and enter the shopping mall 500 through a North entrance 502. Other visitors to the shopping mall 500 park their cars in a South parking area 508 and enter the shopping mall 500 through a South entrance 504. FIG. 4 also depicts a first travel path 550 along a first route from the North parking area 506 which includes a first image capture location 560, a second image capture location 562, and a printing location inside a photo store 510. FIG. 4 also depicts a second travel path 552 along a route from the South parking area 508 which includes a third image capture locations 564, a fourth image capture location 566, and the printing location inside the photo store 510.

The shopping mall 500 includes a number of businesses which are located along the first travel path 550, including Macy's store 522, Sbarro fast-food restaurant 524 and PF Chang restaurant 526. The shopping mall 500 also includes a number of businesses which are located along the second travel path 552, including Kohl's store 530, Subway fast-food restaurant 534 and Cold Stone Creamery ice cream parlor 528. The shopping mall also includes many other stores 540. It will be understood that FIG. 4 represents a simplified version of a shopping mall, and that a typical mall would include a larger number of entrances, stores, and potential parking areas.

Returning to FIG. 3, in receive message from first location step 405 of FIG. 3, a message is received over the communications network 250 from a wireless device, such as camera phone 300A in FIG. 1, positioned at a first location, such as first image capture location 560 in FIG. 4. In some embodiments, the message can be a digital image captured by the user at the first location, such as a picture of a family member captured at first image capture location 560, which can be an area in the shopping mall 500 having an appealing background. In some embodiments, the wireless device does not include image capture capability, and the message received over the communications network 250 from the wireless device can be, for example, a text message which the user sends in response to one or more “treasure hunt” signs located in one or more locations in the shopping mall 500.

In some embodiments, a digital image is captured by the user in response to a sign positioned at the first location. For example, the sign might advise the user about an “Easter egg photo adventure” that the user can participate in. In some embodiments, the sign includes a short code text address, an email address, or a QR (Quick Response) code, which the user can use to access more information about the “Easter Egg photo adventure”. In some embodiments, the user's camera phone 300 can display a message informing the user that they can participate in the “Easter egg phone adventure” at the mall 500. In some embodiments the message is sent to the user's camera phone 300A as an email message or a text message, based on mailing list information maintained by the owner of the shopping mall 500. In some embodiments, the message is controlled by an APP which has been previously downloaded to the user's camera phone 300, and which can automatically inform the user of a photo adventure when the user's camera phone 300 is located near the mall 500, or near other geographic areas which offer other photo adventures.

It will be understood that a plurality of different objects, such as different colored Easter eggs, can be positioned at different image capture locations, such as the first image capture location 560, the second image capture location 562, the third image capture location 564, and the fourth image capture location 566 in FIG. 4. The objects, or signs near the objects, can provide different instructions to the users of wireless capture devices, such as camera phones 300. For example, each of the objects or signs can include a slightly different email or text address. As a result, the capture location of the wireless capture device can be determined based on the address used to receive the image. In other embodiments, the same address can be used to receive the images, and signs located at the different image capture locations can include instructions to the user to provide different text messages, (such as a different letter, number or phrase) which can be used by the service provider 280 to determine the capture location. In some embodiments, the capture location is determined using a geolocation system, such as the GPS receiver 360 in the camera phone 300.

In some embodiments, the guidance can be provided by an automated phone message, such as a telephone call from the “Easter Bunny”, in response to a text message sent by the user of the camera phone 300 to a particular address specified on a sign near an image capture location, such as first image capture location 560 or fourth image capture location 566. The phone message can provide guidance to the parent and child to look for a particular colored Easter egg in a nearby area of the shopping mall 500. The guidance can also ask the parent to photograph their child in front of the Easter egg and to send an MMS message, including the photograph, to a particular email or text address. The user can also be asked to include other information, such as the name of the child depicted in the photograph, as part of the MMS message.

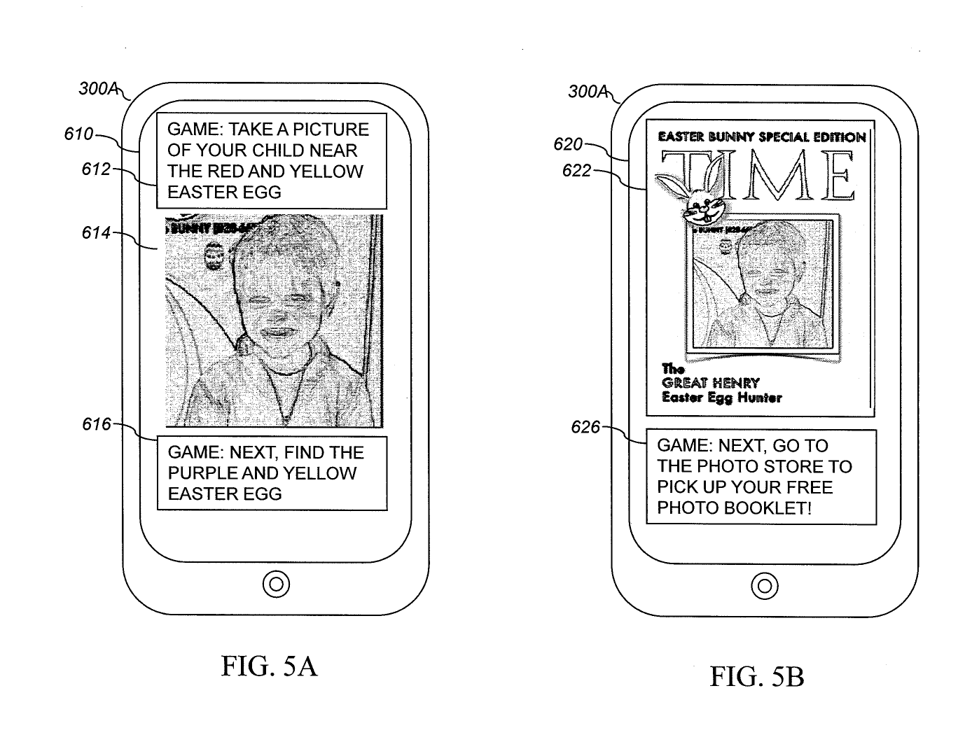

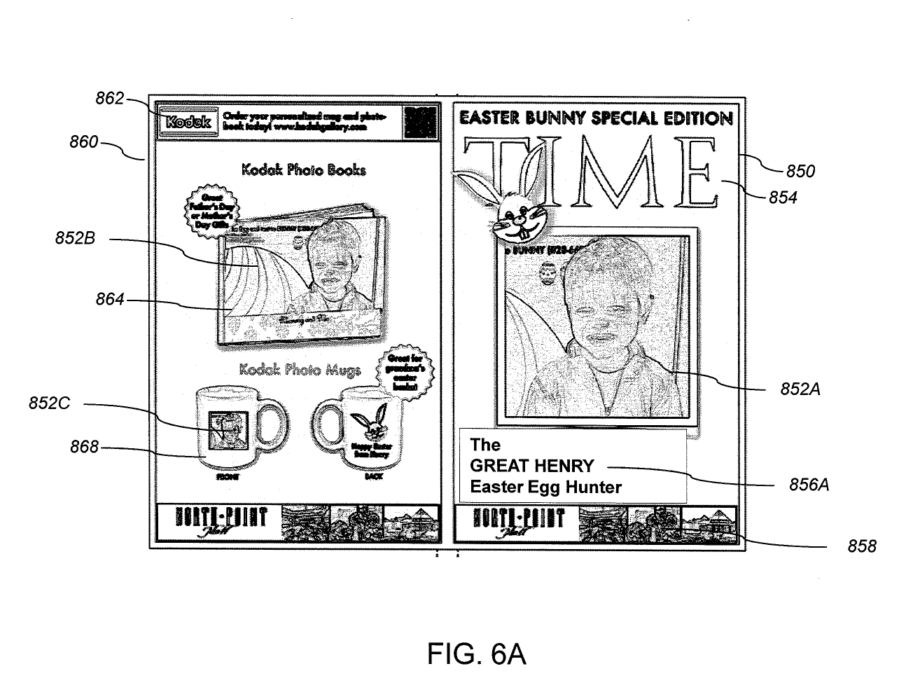

FIG. 5A depicts a user interface screen for capturing images on a wireless device, such as camera phone 300A, which can be used in some embodiments of the present invention. Initial guidance concerning capturing a first digital image is provided by the service provider 280 and transmitted over the communications network 250 to the camera phone 300A. The initial guidance, which is displayed in the initial guidance portion 612 of the user interface display screen 610 of camera phone 300A, instructs the user to “Take a picture of your child near the red and yellow Easter egg”, which is positioned at a first image capture location 560 in the shopping mall 500. The user of the camera phone 300A captures an image in response to this guidance, which is displayed in first user captured image portion 614 of the user interface display screen 610. The camera phone 300A, which is positioned at or near the first image capture location 560, then transmits this first user captured image, corresponding to the image displayed in the first user captured image portion 614, to the service provider 280 as part of a digital message, such as an MMS message.

In some embodiments, service provider 280 uses digital image analysis techniques, as described earlier in reference to FIG. 1, in order to determine whether or not the user captured an image consistent with an intended objective provided by the initial guidance portion 612. For example, the digital image analysis can be used to determine whether the first user captured image depicts at least a portion of a large red and yellow Easter egg, as provided by the initial guidance portion 612. In such embodiments, if it is determined that the received digital image is not consistent with the intended objective, the service provider 280 can provide additional guidance to the user, in order to provide additional instructions or “hints” that help the user locate a landmark or location, in order to capture another image consistent with the intended objective.

In some embodiments, the service provider 280 uses geolocation information transmitted from the wireless device, such as camera phone 300A to determine the location of the user. This geolocation information can include GPS (global positioning system) coordinates. The service provider 280 uses the geolocation information received from the wireless device to determine the travel path in step 415.

Once the service provider 280 has received a user captured image which is consistent with an intended objective, the service provider 280 can transmit additional guidance which instructs the user to move to another location and capture additional images. This enables the customized printed product to include a plurality of digital images captured by the wireless device. For example, the additional guidance portion 616 of the user interface display screen 610 of camera phone 300A can display an additional guidance message “Next, find the purple and yellow Easter egg”. In some embodiments, the guidance can recommend a particular direction, or provide map information or other hints to the user. In some embodiments, the user of the camera phone 300A can send a message which rejects the additional guidance provided by the service provider 280, or which ends the photo adventure. In response, the service provider 280 can determine an alternative objective and transmit guidance to the user which includes guidance concerning the alternate objective, or end the photo adventure and immediately transmit a product offer to the user of the camera phone 330A. For example, the user can decide to reject the next objective based on the difficulty in finding the “purple and yellow Easter egg”, or can end the photo adventure if their child becomes tired, bored, or hungry.

In transmit product offer step 410, the service provider 280 transmits an offer to provide a printed product at a specified printing location to a wireless device, such as camera phone 300A. In some embodiments, service provider 280 provides guidance to direct the user to the printing location. In some embodiments, the guidance includes image and text data, such as an MMS message, but can be of any format or type suitable for transmission over the communication network 250.

FIG. 5B depicts an example of a user interface screen for providing a product offer on a wireless device, such as camera phone 300A, which can be used in some embodiments of the present invention. In the example of FIG. 5B, the product offer is for a free photo booklet. The first page of the free photo booklet is displayed in the product image portion 622 of the user interface display screen 620 of camera phone 300A. A product offer guidance portion 626 of the user interface display screen 620 instructs the user to “Go to the photo store to pick up your free photo booklet”. In some embodiments, the user interface display screen 620 can enable the user to provide a payment in order to obtain the product offered. In some embodiments, the product offer guidance portion 626 of the user interface display screen 620 can provide a map showing a route to the printing location, where the user of the camera phone 300 can pick up their “free photo booklet”.

In some embodiments, the guidance to the user can be provided by placing a phone call to the camera phone 300 for the particular user, using the phone number provided in the MMS message which included the captured digital image. The phone call can be provided using a prerecorded message, such as a message recorded by an actor, pretending to be the Easter Bunny, or a historic figure associated with the theme of the user experience.

In some embodiments, the service provider 280 analyzes the pixel data of one or more of the digital images received from the wireless capture device, such as the 1 camera phone 300A. The service provider then determines, based on this analysis, a recommended printing location for providing the printed product. The recommended location is selected from a plurality of different possible locations; such as the photo store 510 or the toy store 512 in FIG. 4. For example, if the analysis of the pixel data determines that one or more of the images include young children, the toy store 512 is selected as the printing location, in order to provide an opportunity to increase the potential customers visiting the toy store 512. However, if the analysis of the pixel data determines that none of the images include young children, the photo store 510 is selected as the printing location, since it offers products that are more likely to be of interest.

In determine travel path step 415, a travel path between the first location and the printing location is determined. In some embodiments, the travel path is determined by determining a possible return path that the user will take after picking up their printed product. It will be understood that the possible return path can be a travel path which is slightly different than the most direct path between the first location and the printing location. For example, if the shopping mall 500 included first and second floors of stores, the possible return path between the printing location (e.g. Photo Store 510) and the North parking area 506 may be a path along either the first floor or the second floor of the shopping mall 500.

In some embodiments, the travel path is determined by selecting from a plurality of possible travel paths, such as by selecting either first travel path 550 or second travel path 552 described in relation to FIG. 4. In some embodiments, the geolocation information provided by the GPS receiver 360 in the camera phone 300 is recorded as the user moves through at least a portion of the photo experience in the shopping mall 500, in order to determine the travel path

In select prestored information step 420, particular prestored information is selected responsive to the determined travel path. The determined travel path can then be used, for example, to select prestored information about historical sites or retail establishments that the user is likely to pass during their return trip. In some embodiments, the selected prestored information can include text, graphics, or images depicting historical events that occurred at points along the determined travel path. In some embodiments, the selected prestored information can include text, graphics, or images providing information related to retail establishments which are located along the determined travel path. For example, the selected prestored information can include discount coupons for one or more retail establishments along the determined travel path.

In some embodiments, the number of persons depicted in one or more received digital images, or the approximate age of one of more of the persons depicted in the received digital images, can be determined by the service provider 280 using an image analysis technique, and used to help select particular prestored information that is more likely to be of interest to the persons depicted in the received digital images.

In some embodiments, the selected prestored information can include advertisements or coupons for retail establishments along the determined travel path. In some embodiments, a particular advertisement is selected from a plurality of possible advertisements based on various criteria. The criteria can include, for example, the approximate age of one or more of the persons depicted in the captured digital image. For example, if the captured digital image includes one or more children, the particular advertisement can be for an age-appropriate book or toy related to the theme of the experience which can be obtained from a merchant along the determined travel path. The criteria can also include, for example, weather related information such as the current temperature. For example, on warm days the advertisement can provide an offer related to a discount on an ice cream cone at a first merchant along the determined travel path, and on cold days the advertisement can provide an offer related to a discount on a hot drink at a second merchant along the determined travel path. In some embodiments, the coupons can be for a limited time period. In some embodiments, the coupons can be customized so that they can only be used by the particular user of the camera phone 300A. This can be done, for example, by including one of the digital images captured by the user, as part of the coupon.

In provide customized product step 425, a customized printed product is provided at the printing location. The customized printed product can be produced using the digital printer 278 or the kiosk printer 224 shown in FIG. 1. The customized printed product can be printed on a single sheet of paper, or can be a multi-page pamphlet. The customized printed product can be, for example, a printed page, a brochure, a newspaper, a photo book, a calendar, a coffee mug, or a t-shirts. In some embodiments, the customized printed product can be of various sizes, including “poster prints”, and can be offered in picture frames. The customized printed product includes the particular prestored information selected in select prestored information step 420. In some embodiments, the customized printed product includes experience-specific content, such as advertisements or coupons specific to the user's experience. In some embodiments, user-captured images are positioned in the customized photo product in association with prestored information that relates to the respective scenes depicted in the selected images, which were captured in a plurality of locations according to predetermined criteria.

In some embodiments, one or more of the user-captured images can be modified and composited with prestored information. For example, the processor 292 in the computer system 286 can process the received captured image in order to crop out the face, convert the face from a color to a monochrome image, and composite the image of the face into a prestored newspaper template so that the selected image appears to be a photograph in a historic newspaper related to a historic site which serves as the theme of the experience.

In some embodiments, customized digital media products are provided by the service provider 280. For example, DVD writer 279 in FIG. 1 can be used to produce CDs or DVDs, such as PictureCDs having the prestored information selected in step 420.

In some embodiments, a digital product is provided to the user, for example in the form of a pdf file. The digital product can include digital coupons which are viewed on the color image display 332 of the camera phone 300 and redeemed by a merchant using barcode scanning of the screen, or using an NFC (near field communication) transaction.

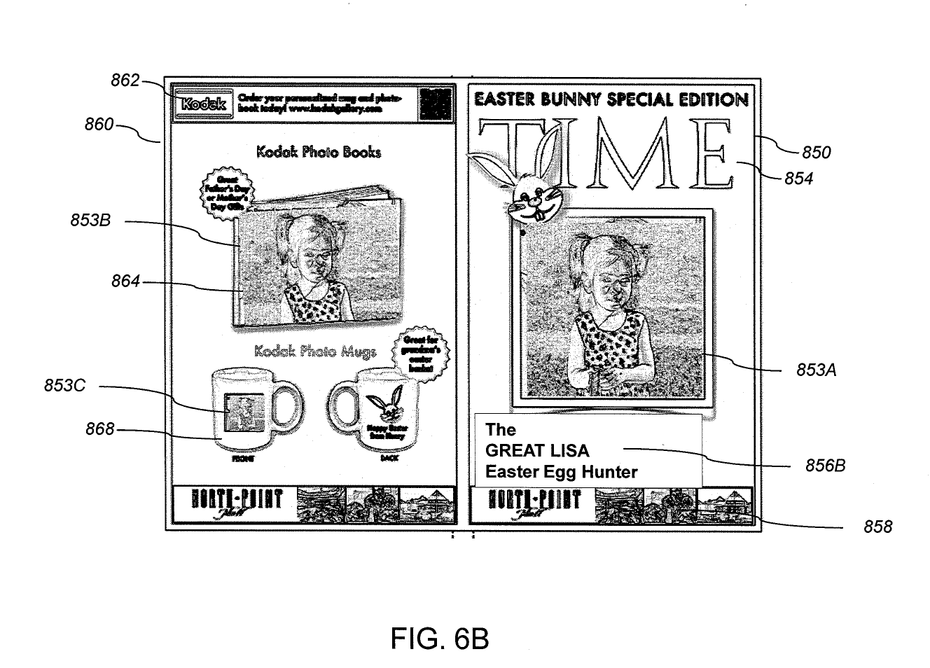

FIGS. 6A and 6B depict pages of customized printed products which have been customized for two different participants. FIG. 6A depicts the first page 850 and the last page 860 of the printed product, which is a small, multi-page photo booklet. Page 850 is a cover page and includes one captured image, 852A, which was captured by a particular user of camera phone 300A. In this example, the captured image 852A was captured by a parent of the child depicted in the image at first image capture location 560, which is near the “purple and yellow” Easter egg. As described earlier in reference to step 405, captured image 852A was received by the service provider 280 as part of a digital message transmitted by the camera phone 300A, in response to guidance from the service provider 280 related to first image capture location 560. The digital message also included the child's name “Henry”.

The first page 850 also includes selected prestored information, such as the text “Easter Bunny Special Edition” 854 and related graphics information 858 describing the location of the egg hunt (e.g. North Point Mall). The first page 850 also includes a title 856A “The GREAT HENRY Easter Egg Hunter” which is customized to include the name of the child, “Henry”, who participated in the photo experience.

FIG. 6A also depicts a last page 860 of the printed product. The last page 860 includes an advertisement 862 for Kodak Photo Books and Kodak Photo Mugs. The advertisement 862 uses one of the received captured digital images positioned with other prestored information. For example, the last page 860 depicts a photo book 864 which includes a captured image 852B that is a different sized and cropped version of the captured image 852A on the first page 850. The last page 860 also depicts a photo mug 868 which includes a captured image 852C that is a different sized and cropped version of the captured image 852A on the first page 850. Both the photo book 864 and photo mug 868 are examples of advertising information related to another product (e.g. a photo book or photo mug) which use at least one of the images captured using the camera phone 300A and also use prestored information to depict the product offering.

FIG. 6B depicts a photo product for a second user. FIG. 6B is similar to FIG. 6A, except that the digital images 852A, 852B, and 852C, and the title 856A which depict or name Henry in FIG. 6A, are replaced with digital images 853A, 853B, and 853C and title 856B, which depict or name “Lisa” in FIG. 6B. In the example of FIG. 6B, the received digital image and text “Lisa” was received from a user of second camera phone 300B from the fourth capture location 566, so the background of the captured image 853A which includes Lisa is different than the background of the captured image 852A which includes Henry.

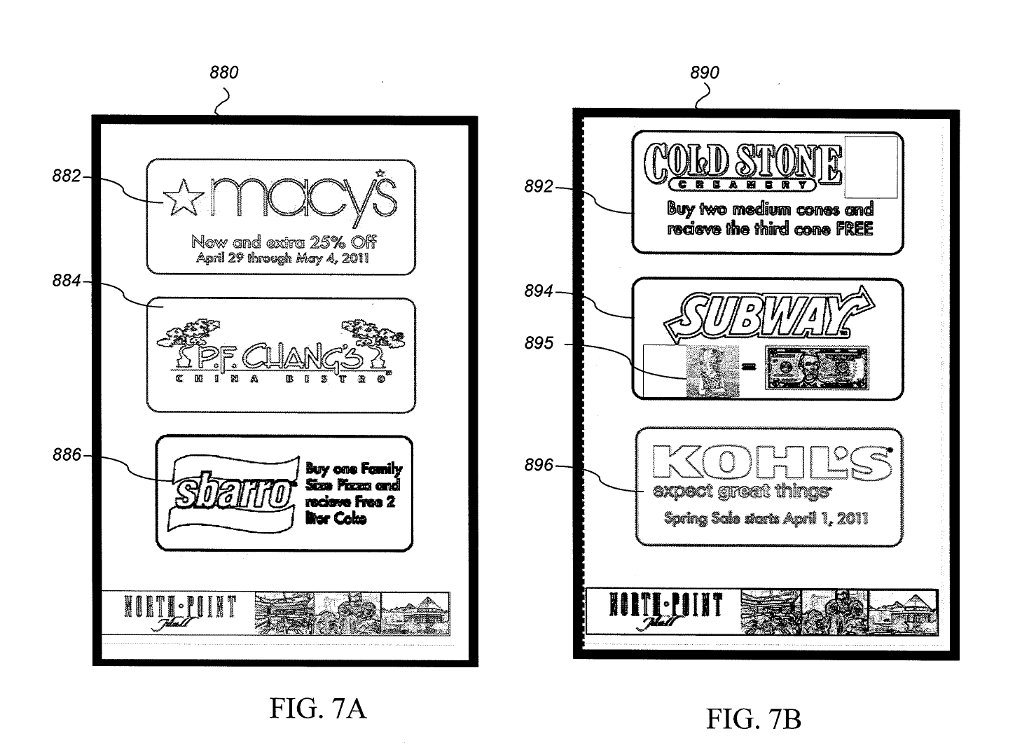

FIG. 7A depicts a third page 880 of the customized printed product for the user of the first camera phone 300A, which captured a digital image at the first image capture location 560. The third page 880 includes prestored information which was selected responsive to the determination of the first travel path 550 between the first image capture location 560 and the printing location (e.g. Photo Store 510) in FIG. 4. The third page 880 includes three advertisements in the form of coupons 882, 884, and 886. Coupon 882 provides a discount of 25% at the Macy's store 522, which is located along first travel path 550. Coupon 884 provides information about the PF Chang restaurant 526, which is also located along first travel path 550. Coupon 886 provides a discount offer from a Sbarro restaurant 524 which is also located along first travel path 550. In some embodiments, the prestored advertising information used for coupons 882, 884, and 886 is selected responsive to the number of persons depicted in the captured image or the approximate age of one or more of the persons depicted in the captured image, or responsive to the other metadata, as described earlier in reference to step 420.

FIG. 7B depicts a third page 890 of the customized printed product for the user of the second camera phone 300B, which captured a digital image at the fourth image capture location 566. The third page 890 includes prestored information which was selected responsive to the determination of the second travel path 552 between the fourth image capture location 566 and the printing location (e.g. Photo Store 510) in FIG. 4. The third page 890 includes three advertisements in the form of coupons 892, 894, and 896. Coupon 892 provides a discount on ice cream cones at Cold Stone store 528 which is located along second travel path 552. Coupon 894 provides a “cash equivalent” discount related to Subway fast food restaurant 534 which is also located along second travel path 552. Coupon 894 also includes a differently sized and cropped image 895 of one of the captured images of Lisa. Cropped image 895 is positioned within the second coupon 894 along with other prestored advertising related information. Coupon 896 provides information about a sale at Kohl's store 530, which is also located along second travel path 552.

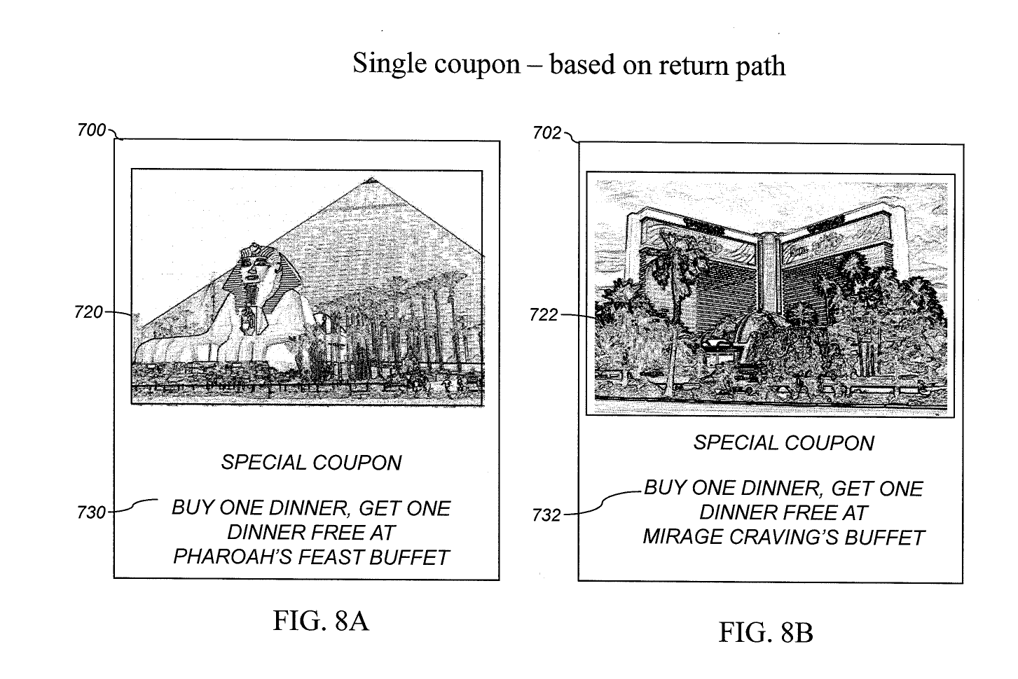

FIG. 8A and FIG. 8B depict examples of two different customized printed products for two different users of wireless devices positioned at two different locations in the city of Las Vegas, Nev. FIG. 8A depicts a first customized printed product 700, which includes an image 720 of a first attraction which was selected responsive to the travel path between a capture location of the first user and the printing location. Customized printed product 700 also includes a first discount offer 730 related to the first attraction depicted in image 720. FIG. 8B depicts a second customized printed product 702, which includes an image 722 of a second attraction which was selected responsive to the travel path between a capture location of the second user and the printing location. Customized printed product 702 also includes a second discount offer 732 related to the second attraction depicted in image 722.

In some embodiments, some or all of the steps described in reference to FIG. 3 can be provided by an image capture device, such as camera phone 300. In some embodiments, the camera phone 300 is a smart phone, and the service provider 280 provides a downloadable software application (“APP”) over the communication network 250 to the camera phone 300. The camera phone 300 is one example of an image capture device, and includes an image sensor array 314 for capturing a digital image of a scene, a color display 332, a digital processor 320 which serves as a data processing system, image data memory 330 which serves as a storage memory for storing captured images; and firmware memory 328 which serves as a program memory. The firmware memory 328 is communicatively connected to digital processor 320.

In this example, the instructions provided in the APP can control the digital processor 320 in order to display, on the color display 332, guidance information for capturing a first digital image at a first location; and enable the camera phone 300 to capture a first digital image using the image sensor array 314 and store the first digital image in image/data memory 330. In some embodiments, the instructions provided in the APP can control the digital processor 320 in the camera phone 300 to determine a travel path between the first location and a printing location. In some embodiments, the instructions provided in the APP can then select particular prestored information responsive to the determined travel path. In some embodiments, the APP can then format the information to be used to create a customized printed product, and can transmit the formatted information over the communications network 250, so that the formatted information can be used to create the customized printed product. It will be understood that in some embodiments of the present invention, the travel path can be a relatively short distance, such as the distances of a few hundred feet associated with walking through a portion of a shopping mall, park or entertainment area. It will be understood that in some other embodiments of the present invention, the travel path can be a relatively longer distance, such as a few miles, typically covered by walking (or using mass transit) in the center portion of a city such as Las Vegas or Edinburgh. It will be understood that in some other embodiments of the present invention, the travel path can be a very long distance, such as hundreds of miles, if the user is traveling between destinations using automobile, train, or air transportation. In such an example, the capture location is in an airport or train station in a first country, and the printing location is in an airport or train station in a second country. In some embodiments, a reservation for airplane flights or train transportation is used to determine the travel path

In the foregoing detailed description, the method and apparatus of the present invention have been described with reference to specific exemplary embodiments thereof. It will, however, be evident that various modifications and changes can be made thereto without departing from the broader spirit and scope of the present invention. The present specification and figures are accordingly to be regarded as illustrative rather than restrictive.

A computer program product can include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to certain preferred embodiments thereof, but it will be understood that variations and modifications can be effected within the spirit and scope of the invention.

### PARTS LIST

214 System
218 Customer Computer
220 Communication Services Provider (CSP)
222 Communication Services Provider (CSP)
224 Kiosk Printer
240 Cellular Provider Network
250 Communication Network
268 Transportation Vehicle
270 Fulfillment Provider
272 Web Server
274 Commerce Manager
275 Fulfillment Manager
276 Fulfillment Manager
278 Digital Printer
279 DVD Writer
280 Service Provider
282 Web Server at Service Provider
284 Account Manager
286 Computer System
288 Customer Database
290 Custom Content Database
292 Processor
300A Camera phone at location A
300B Camera phone at location B
300 Camera phone
302 Flash
304 Lens
310 CMOS Image Sensor
312 Timing Generator
314 Image Sensor Array
316 AID Converter
318 DRAM Buffer Memory
320 Digital Processor
322 RAM
324 Real Time Clock
328 Firmware Memory
330 Image/Data Memory
332 Color Display
334 User Controls
340 Audio Codec
342 Microphone
344 Speaker
350 Wireless Modem
352 RF Channel
360 GPS Receiver
362 Dock Interface
364 Dock Recharger
400 Store Prestored Information
405 Receive Message From First Location
410 Transmit Product Offer
415 Determine Travel Path
420 Select Prestored Information
425 Provide Customized Product
500 Shopping Mall
502 North Entrance
504 South Entrance
506 North Parking Area
508 South Parking Area
510 Photo Store
512 Toy Store
522 Macy's Store
524 S'Barro Restaurant
526 PF Chang Restaurant
528 Cold Stone Restaurant
530 Khol's Store
534 Subway Fast Food
540 Stores
550 First Travel Path
552 Second Travel Path
560 First Image Capture Location
562 Second Image Capture Location
564 Third Image Capture Location
566 Fourth Image Capture Location
610 User Interface Display Screen
612 Initial Guidance Portion
614 First User Captured Image Portion
616 Additional Guidance Portion
620 User Interface Display Screen
622 Product Image Portion
626 Product Offer Guidance Portion
700 First Custom Printed Product
702 Second Custom Printed Product
720 Image
722 Image
730 First Discount Offer
732 Second Discount Offer
850 First Page
852A Captured Image
852B Captured Image
852C Captured Image
853A Captured Image
853B Captured Image
853C Captured Image
854 Text
856A Title
856B Title
858 Prestored Graphics Information
860 Last Page
862 Advertisement
864 Photo Book
868 Photo Mug
880 Third Page
882 Coupon
884 Coupon
886 Coupon
890 Third Page
892 Coupon
894 Coupon
895 Cropped Image
896 Coupon

1. A method for providing customized printed products at a printing location, comprising:
a) storing a collection of prestored information associated with a plurality of different points along travel paths,
b) receiving, over a wireless communications network, a digital message from a wireless device positioned at a first location;
c) transmitting, to the wireless device, an offer to provide a printed product at the printing location;
d) determining a travel path between the first capture location and the printing location;
e) selecting particular prestored information responsive to the determined travel path; and
f) providing a customized printed product at the printing location, wherein the customized printed product includes the selected particular prestored information.

2. The method according to claim 1, wherein the digital message includes a digital image and wherein the customized printed product is a photo product that includes at least a portion of the digital image.

3. The method according to claim 1 wherein the customized printed product includes a plurality of digital images captured by the wireless device.

4. The method according to claim 3 wherein the printed product includes an advertisement.

5. The method according to claim 4 wherein the advertisement relates to a business along the travel path.

6. The method according to claim 1 further including receiving geolocation information from the wireless device and using the geolocation information to determine the travel path.

7. The method according to claim 1 wherein the digital message includes a digital image and wherein the method includes analyzing pixel data of the digital image to determine the travel path.

8. The method according to claim 1 wherein the wireless device is a wireless capture device and wherein the method further includes positioning a plurality of different objects at different locations, providing guidance to the user of the wireless capture device to capture and transmit a digital image of one of the different objects, and analyzing the pixel data of the received digital image to determine the travel path.

9. The method according to claim 1 wherein the wireless device is a wireless capture device and wherein the method further includes positioning a plurality of different objects at different locations, wherein the different objects provide different instructions to the user of the wireless capture device, receiving information from the wireless capture device, and using the received information to determine the travel path.

10. The method according to claim 9 wherein the received information is provided by instructing the user to provide different text messages at different locations.

11. The method according to claim 9 wherein the received information is provided by instructing the user to send a message to different addresses, at different locations.

12. The method according to claim 1 further including receiving weather related information, and wherein the particular prestored information is selected responsive to the weather related information.

13. The method according to claim 1 further including receiving time of day related information, and wherein the particular prestored information is selected responsive to the time of day information.

14. The method according to claim 1 wherein the wireless device is a wireless capture device and wherein the method further includes receiving and evaluating a digital image captured by the wireless capture device to determine the approximate age of a person depicted in the digital image, and wherein the particular prestored information is selected responsive to the approximate age of the person depicted in the digital image.

15. The method according to claim 9 wherein an advertisement includes at least a portion of the digital image.

16. The method according to claim 1 wherein the wireless device is a wireless capture device and wherein the method further includes
g) analyzing the pixel data of a digital image received from the wireless capture device and determining based on such analysis a recommended printing location for providing the printed product, wherein the recommended location is selected from a plurality of different possible locations;
h) transmitting information concerning the recommended location over the wireless communications network to the wireless capture device; and
i) providing the printed photo product to the user at the recommended printing location.
